(19) United States
(12) Patent Application Publication
(10) Pub. No.: US 2022/0089229 A1
(43) Pub. Date: Mar. 24, 2022

(54) Vortex Generator

(71) Applicant: Swayguard Holdings LLC, Midlothian, TX (US)

(72) Inventor: Mark CALDER, Midlothian, TX (US)

(21) Appl. No.: 17/407,684

(22) Filed: Aug. 20, 2021

Related U.S. Application Data
(60) Provisional application No. 63/181,048, filed on Apr. 28, 2021.
(60) Provisional application No. 63/068,241, filed on Aug. 20, 2020.

(51) Int. Cl. B62D 35/00; B62D 37/02

(52) U.S. Cl. CPC B62D 35/001; B62D 37/02

(57) ABSTRACT

A vortex generator for reducing bow waves on a vessel. The vortex generator has a base and an upwardly extending fin. The vortex generator is placed on a vessel, such as a trailer. When the trailer passes another vessel, the vortex generator decreases the bow waves created by the Bernoulli effect. This reduces the vehicles from being pressed toward one another when passing. Further, when the vortex generators are placed atop a trailer, they reduce the impact of crosswinds.

### PRIORITY

The present application claims benefit of U.S. Provisional Application No. 63/068,241 filed Aug. 20, 2020, and U.S. Provisional Application No. 63/181,048, filed Apr. 28, 2021, all of which are hereby incorporated herein by reference in their entirety and made part of the present application.

### BACKGROUND OF THE INVENTION

### Technical Field

The present invention relates to a system and method for stopping sway caused by passing vehicles and reducing the impact of crosswinds

### Description of Related Art

When a truck, car, or trailer passes another vehicle traveling at high speeds, the truck or trailer gets sucked closer to the second vehicle. This causes unnerving swaying. Furthermore, crosswinds can cause a truck, car, trailer, or other large vessel, to sway. This is also undesirable. Consequently, there is a need to diminish these effects

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a top schematic of a vessel and a trailer in one embodiment;

FIG. 2A is a perspective view of the vortex generator in one embodiment;

FIG. 2B is a front view of a vortex generator in one embodiment;

FIG. 2C is a side view of a vortex generator in one embodiment;

FIG. 3 is a schematic showing Bernoulli's Venturi theory;

FIG. 4 is a top schematic view of a trailer with a vortex generator in one embodiment;

FIG. 5 is a front view of a trailer with a vortex generator in one embodiment;

FIG. 6 is a front perspective view of a trailer with a vortex generator in one embodiment;

FIG. 7 is a rear schematic view of a trailer in one embodiment;

FIG. 8A is a side view of a trailer with vortex generators in one embodiment;

FIG. 8B is a rear view of a trailer with vortex generators in one embodiment;

FIG. 9 is a top view of a trailer with vortex generators with no crosswinds;

FIG. 10 is a top view of a trailer with vortex generators with crosswinds.

FIG. 11 shows the data and trendline for the first run without vortex generators;

FIG. 12 shows the data and trendline for the second run with vortex generators on the front of the trailer;

FIG. 13 shows the data and trendline for the third run with vortex generators on the front and rear of the trailer;

FIG. 14 shows a table summarizing the results.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

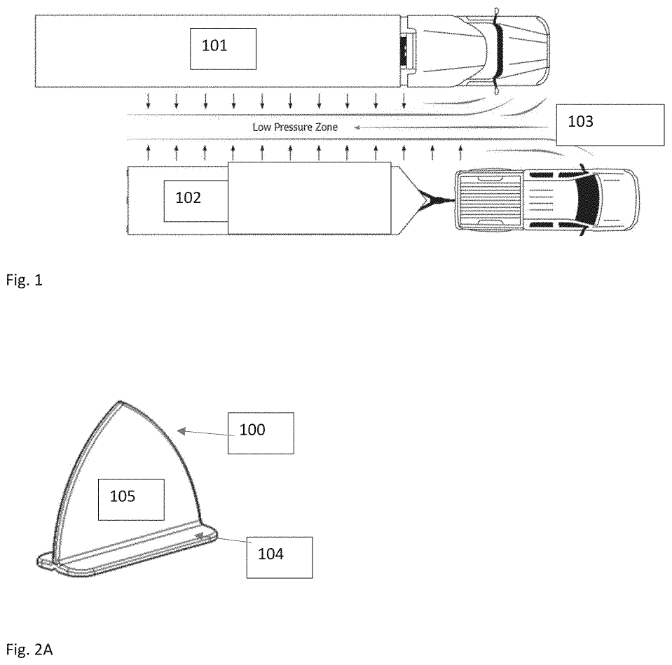

FIG. 1 is a top schematic of a vessel and a trailer in one embodiment. As shown, a large vessel 101 is traveling adjacent to a user's trailer 102. The large vessel 101 can be any moving vessel. As depicted the large vessel 101 is a semi-truck. This is for illustrative purposes only and should not be deemed limiting. The large vessel 101 can be a ship, boat, trailer, etc.

The second vehicle, the trailer 102 can likewise be any moving vessel. It should be noted that while the term trailer has been used, this is for illustrative purposes only and should not be deemed limiting. The vortex generators 100, described below herein, can be added to virtually any vessel, including a truck, semi-truck, ship, motorhome, trailer, etc. Thus, while the term “trailer” is utilized, it should be understood that these other vessels can also be used rather than a trailer.

As demonstrated, when the large vessel 101 passes the trailer 102, the trailer 102 is drawn toward the large vessel 101 due to a low-pressure zone. This is a potentially dangerous phenomenon if the drivers are not paying attention.

The cause for this phenomenon is Bernoulli's Venturi theory, shown in FIG. 3. FIG. 3 is a schematic showing Bernoulli's Venturi theory. This theory states that increased velocity through a venturi causes a drop in the pressure. The same effect occurs when a large vessel 101 passes a trailer 102 being towed by a car or truck. The air between the vehicles is accelerated by being trapped by the vehicles bow wave 103, as shown in FIG. 1. The resulting low pressure is accordingly distributed along the side of the trailer 102 and the large vessel 101. The low pressure can cause the trailer 102 and the large vessel 101 to suck in toward one another. If either driver is not properly attentive, that driver can lose control of the vehicle.

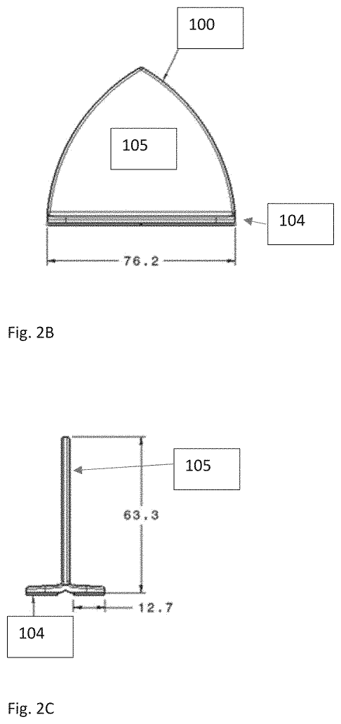

FIGS. 2A-C show a vortex generator 100 which reduces or eliminates the bow wave 103. FIG. 2A is a perspective view of the vortex generator in one embodiment. FIG. 2B is a front view of a vortex generator in one embodiment. FIG. 2C is a side view of a vortex generator in one embodiment. Various dimensions of a vortex generator are shown in FIGS. 2A-C. These are for illustrative purposes only and should not be deemed limiting.

The vortex generator 100 is a device which reduces or eliminates the bow wave 103 on the vehicle or trailer to which they are attached. This dramatically decreases a large portion of the Bernoulli effect. Accordingly, this decreases the suction that the trailer 102 will feel which being passed by a large vessel 101. The same effect is realized when the vortex generator 100 is placed on a vessel 101.

As depicted, the vortex generator 100 has a base 104 and an upwardly extending fin 105. The base 104 can comprise a flat or curved bottom. The base 104 couples to the trailer 102, as described below. In one embodiment the base 104 comprises an acrylic foam adhesive tape to secure the base 104 to the trailer 102, but virtually any method or device to attach the base 104 to the trailer 102 or vessel 101 can be used. Other adhesive mechanisms can also be utilized including tape, glue, screws, welding, and the like.

It should be noted that while FIG. 2 depicts an embodiment wherein the vortex generator 100 is applied to an existing trailer 102, this is for illustrative purposes only and should not be deemed limiting. In other embodiments, for example, the vortex generator 100 is made and integrated into the trailer 102 or other vessel 101.

As noted, the vortex generator 100 has a fin 105 which extends upward from the base 104. In one embodiment the fin 105 is planar and arcs at each side to a high point located approximately in the horizontal center of the vortex generator 100. Thus, in one embodiment the vortex generator 100 gives the appearance of a shark fin.

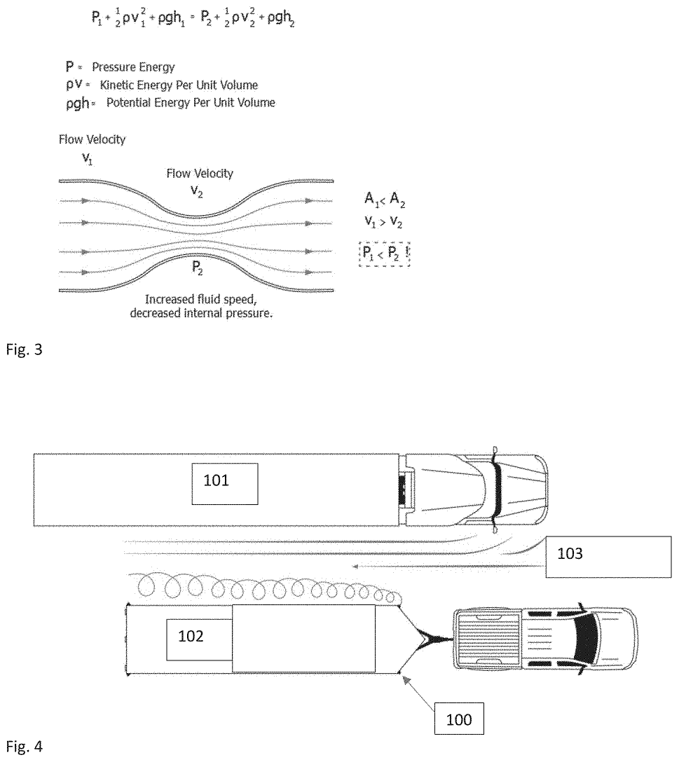

Turning now to FIG. 4, FIG. 4 is a top schematic view of a trailer with a vortex generator in one embodiment. As noted, in one embodiment the vortex generator 100 decreases or eliminates the bow wave 103 of the trailer 102. As can be seen in FIG. 4, the leading edge of the trailer 102 has one or a series of vortex generators 100. As shown, each leading corner of the trailer 102 has a vortex generator 100. These vortex generators 100 disrupt the flow off of the front of the trailer and eliminates or substantially decreases the bow waves 103. In doing so, this significantly reduces the Bernoulli effect. The result is that the trailer 102 does not get sucked into the adjacent large vessel 101. Since the effective frontal area of the trailer is the sweep of the bow wave, reducing the bow wave as the effect of decreasing the projected frontal area.

There are numerous benefits from the vortex generator. As noted, one is reduction of the Bernoulli effect which results in the trailer 102 not getting sucked into an adjacent large vessel 101. Thus, safety is increased. As previously noted, if a driver was not paying sufficient attention, the driver could lose control. When the Bernoulli effect is reduced, the effect of the trailer 102 being pulled toward the large vessel 101 is significantly reduced. Thus, increased safety is an advantage.

Second, aside from increasing safety, the vortex generator 100 results in a gentler ride for both the driver and other passengers. Previously, the Bernoulli effect resulted in the entire vehicle and/or trailer shaking as it was being pulled toward the large vessel 100. Because this effect is reduced, the drive is calmer for both the driver and the passenger.

Third, the vortex generator 100 reduces aerodynamic drag, and accordingly reduces fuel consumption and decreased emissions. Because the effective frontal area of the trailer 102 is the sweep of the bow wave 103, reducing the bow wave decreases the projected frontal area. This results in decreased aerodynamic drag. Thus, a third advantage is decreased fuel costs and decreased environmental impact.

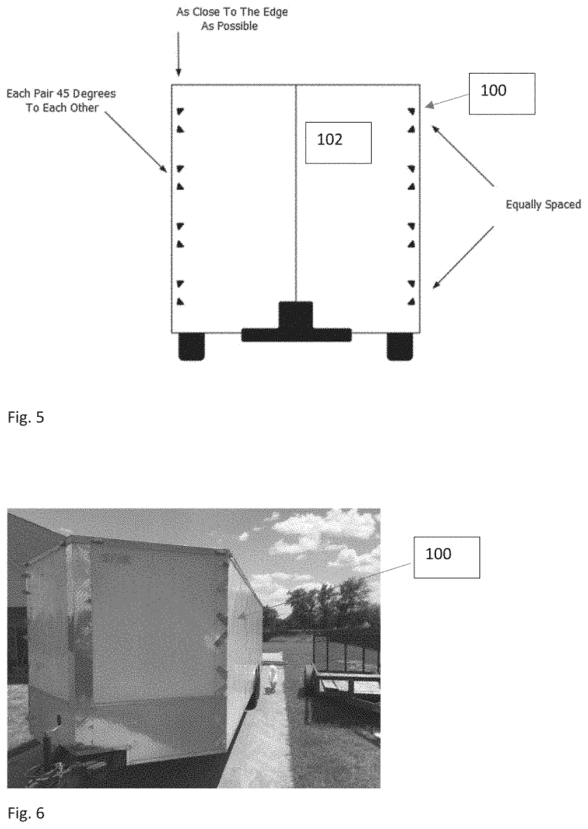

As noted, one or more vortex generators 100 can be placed on the trailer 102. FIG. 5 is a front view of a trailer with a vortex generator in one embodiment. In this embodiment, the vortex generators 100 are placed as a pair with each pair 45 degrees relative to one another and pointing toward the other.

As depicted, there are four pairs of vortex generators 100 equally spaced along the height of the trailer 102 on each side of the trailer 102. Thus, as depicted, there is a total of eight pairs of vortex generators 100. Because the Bernoulli effect is felt by adjacent vehicles, in this embodiment the vortex generators 100 are only placed along the vertical sides of the trailers 102. Put differently, the vortex generators 100 are placed on sides which will be adjacent to another vehicle. Thus, the vortex generators 100 are not placed adjacent the top side (roof) or the bottom side (the floor) of the trailer. However, vortex generators 100 can be placed on the top or bottom for the purpose of reducing drag.

As shown, the vortex generators 100 are placed on the extreme edge of the front of the trailer 102. This causes the bow waves to be broken.

Turning to FIG. 6, FIG. 6 is a front perspective view of a trailer with a vortex generator in one embodiment. As can be seen, they are placed on the extreme edge of the front of the trailer 102. The fin 105 points outwardly away from the face of the trailer. They are substantially vertically aligned along the height of the trailer.

An additional form of trailer instability occurs when a large vehicle such as a semi-truck, approaches from the rear. The towed trailer, as an example, generates a pair of trailing vortexes. When one of these vortexes comes in close proximity to the bow wave of a passing vehicle, such as a semi-truck in an adjacent lane, another suction effect is created again according to Bernoulli's theory. The driver of the towed trailer 102 will feel a sharp tail wag. However, if a second set of vortex generators 100 are added at the end of the trailer using the same or similar pattern as the forward vortex generators 100, the resulting disruption of the flow over the edge of the trailer 102 reduces the size of the twin trailing vortexes that were attaching to the back of the trailer. Thus, in one embodiment one or more vortex generators are placed along the back end of the trailer in a similar manner that they are placed up front. Turning back to FIG. 4 the front vortex generators point forward and outwardly, whereas the rear vortex generators point outwardly.

The vortex generators 100 can comprise virtually any material. They can be plastic, rubber, metal, wood, and combinations thereof In one embodiment they comprise polypropylene. In another embodiment they comprise ABS. They can be manufactured in a variety of methods as well. In one embodiment the vortex generators 100 are 3D printed. In other embodiments they are injection molded. Virtually any method of manufacturing which can result in the vortex generator 100 depicted can be utilized.

As noted, in some embodiments the vortex generator 100 is added to a trailer 102. In some embodiments the vortex generator 100 has an adhesive that allows it to adhere to a surface. In other embodiments the vortex generator 100 utilizes a screw, bolt, or the like to mechanically couple the vortex generator 100 to the trailer 102.

The vortex generator 100 is placed in the location described herein to reduce the bow waves. In embodiments wherein the vortex generators 100 are added to a trailer 102, the vortex generator 102 can be coupled to the trailer via the methods described herein. In one embodiment, previously discussed, pairs of vortex generators 100 are placed on the extreme end of the trailer face.

Additionally, as noted, in other embodiments rather than being added subsequently, the vortex generator 100 is built and manufactured simultaneously with the trailer 102 or vessel 101.

The results of the vortex generators is significant. A test trailer has recorded over 10,000 miles of long-distance driving. To obtain relevant data, the barometric pressure on the driver's side of a towed 24″ trailer was measured. The intent was to determine if the vortex generators reduces the variation of air pressure while another vehicle passes on the side of the test trailer. The barometric pressure was measured, via sensor, before and during a semi-truck driving next to the test vehicle.

A BMP 180 microcontroller was used to monitor barometric pressure. A sensor was installed in the middle of the driver's side of the 24″ trailer. The trailer was pulled at highway speeds along a selected stretch of North/South running highway. A video recording was taken to align the videoed timestamp with the pressure readings. By referencing the video timestamp, sections of sensor data were extracted which aligned with 5 seconds before a truck passed and 5 seconds into the truck driving next to the trailer.

The first trial was a baseline control without the vortex generators 100 installed.

The second was run with the vortex generators 100 installed on the front of the trailer. The third was run with vortex generators 100 installed on the front and rear of the trailer. For each trial, the same route and speed and same time of day was utilized within the same weather conditions.

As can be seen, pressure difference was drastically reduced in the second and third runs. Accordingly, the sway force, measured in pounds, was reduced by 74% in the second run and 86.4% in the third run compared to the first run. This is a significant reduction in the sway force, or sideways force. Thus, the vortex generators reduce sway from passing vehicles and provides a sense of stability, safety, and peace of mind to the driver. The results show a quantified benefit of reducing the sideways force. The sway force can be calculated based on the pressure or it can be measured.

While one embodiment has been described for reducing sway caused by passing vehicles, the vortex generators have other benefits as well. One such benefit is handling crosswinds.

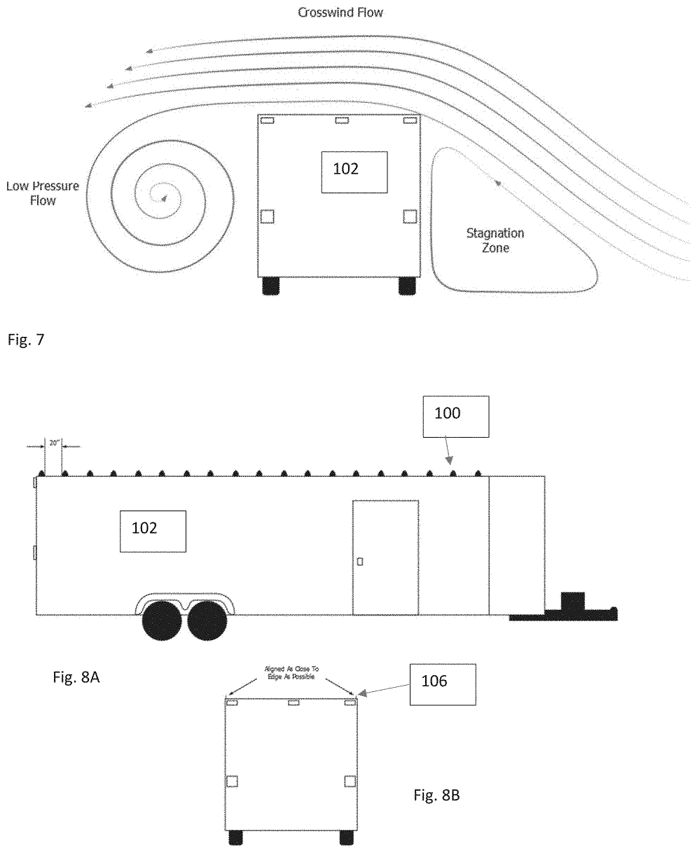

FIG. 7 is a rear schematic of a trailer in one embodiment. The trailer 102, as noted above, can comprise a trailer, vessel, etc. This is for illustrative purposes only and should not be deemed limiting. The trailer 102 can be a ship, boat, trailer, semi-truck, etc.

The crosswind impacts the vessel 101, but it also significantly impacts trailers 102 being hauled behind such vessels 101. The reason is that the trailer 102 connects pivotally to the vessel 101, so the crosswind impacts are felt by the towing vessel. As above, the vortex generators 100, described herein, can be added to virtually any vessel, including a truck, semi-truck, ship, motorhome, trailer, etc. Thus, while the term “trailer” is utilized, it should be understood that these other vessels can also be used rather than a trailer.

When a vessel 101 encounters cross winds this causes the vessel 101 and/or trailer 102 to sway. In extreme conditions the trailer can be blown over. The larger the surface area of the trailer, the greater the crosswind effect.

While it may appear that the crosswind is pushing the trailer 102 over, it is actually the negative pressure on the downstream side which creates a suction force to pull the trailer 102 over. Before the gust strikes the trailer's 102 side, it is deflected up and over the trailer. This is due to a stagnation zone which sets up on the windward side of the trailer 102, as shown in the figure. The stagnation zone serves to deflect the oncoming wind gust over the edge of the trailer. The main mass of air flows over the near edge of the trailer 102 where the flow is tripped and a large spiraling vortex forms on the leeward or downwind side of the trailer. This large vortex creates a low-pressure core of low pressure which is distributed across the area of the leeward side of the trailer 102. This is the suction force which draws the trailer 102 away.

In one embodiment, the creation of a large vortex is prevented by using the energy to instead create quickly dissipating smaller vortexes. This is accomplished, in one embodiment, by using at least one vortex generator 100. In one embodiment, and the embodiment discussed herein, a plurality of vortex generators are utilized.

The vortex generator 100, when properly placed, reduces or eliminates the creation of large low-pressure vortexes on the leeward side of a trailer. Accordingly, this decreases the suction that the trailer 102 will feel when it encounters a crosswind.

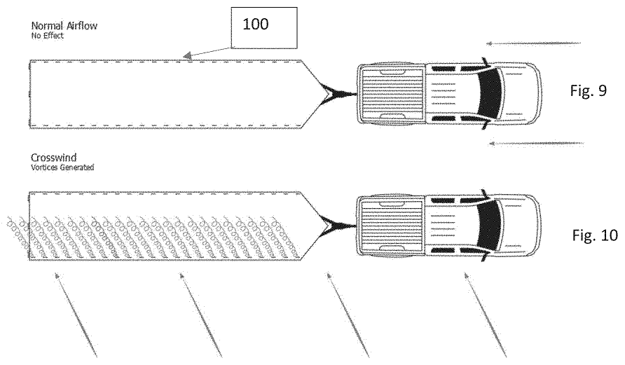

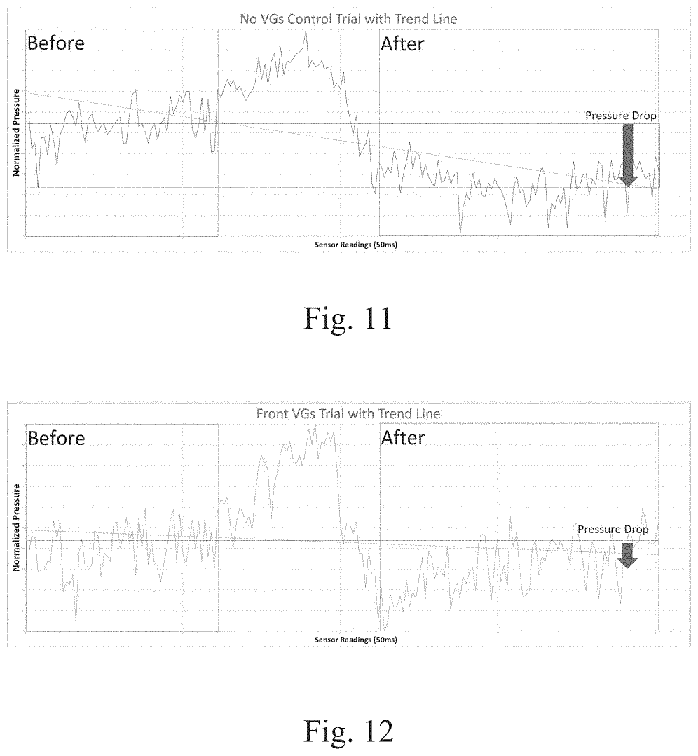

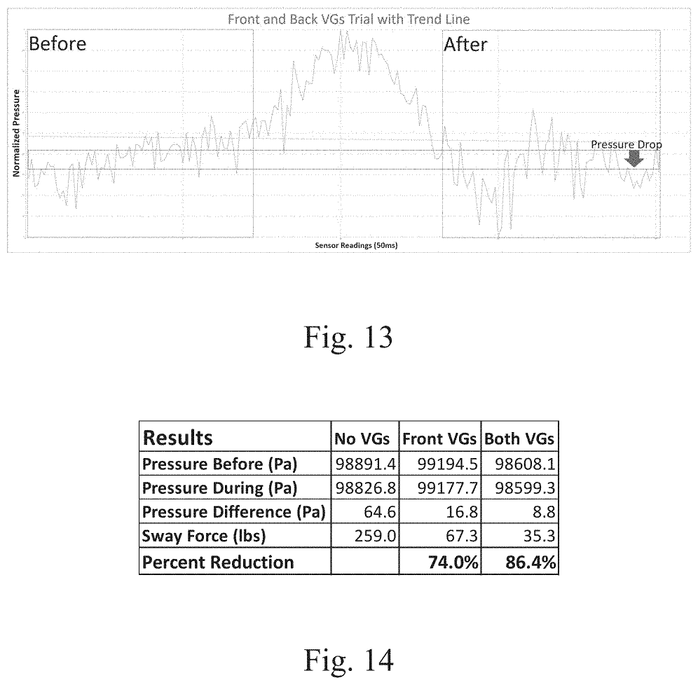

Turning now to FIGS. 8A and 8B, these figures depict an embodiment where a tailer 102 has a plurality of vortex generators 100 placed along its upper edge 106. FIG. 8A is a side view of a trailer with vortex generators in one embodiment, and FIG. 8B is a rear view of a trailer with vortex generators in one embodiment.

As can be seen the vortex generators 100 are placed as close to the edge 106 of the trailer 102, or vessel 101, as possible. They resemble saw teeth. They are placed on the sides of the trailer 102 and they run the length of the trailer 102. They are orientated such that the fin 105 is parallel with the length of the trailer 102 and the direction of travel. The vortex generators are placed atop each top side edges of a trailer, as shown. In this fashion, the vortex generators 100 have no effect with normal airflow. However, as described in more detail below, when a crosswind encounters the vortex generators 100, the generators 100 create a plurality of quickly dissipating vortexes. These vortexes prevent the formation of larger low-pressure vortexes which cause swaying of the trailer 102.

As shown the vortex generators 100 are spaced about 20 inches apart. This is for illustrative purposes only and should not be deemed limiting. The specific spacing will depend upon the size of the vortex generator 100, the size of the trailer 102, etc.

As seen in FIG. 8B, the vortex generators 100 are close to the top edge 106.

They are also barely visible, in this embodiment, as the fin 105 appears very thin compared to the width of the trailer 102. While one embodiment has been described wherein the vortex generators are placed on the top edge, in other embodiments they can be placed on the bottom edge as well.

Turning now to FIG. 9, FIG. 9 is a top view of a trailer with vortex generators with no crosswinds. The vortex generators 100 are placed along the top edges 106 of the trailer 102 as shown in FIGS. 8A and 8B. Because in one embodiment the fin is oriented to be parallel with the direction of travel, with normal airflow the vortex generators have no effect. However, FIG. 10 shows the same trailer 102 with crosswind coming from the bottom of the figure as depicted. The crosswind encounters the vortex generator 100 on the upstream side of the trailer 102. These vortex generators 100 disrupt the flow off of the upstream side of the trailer and creates a series of small vortexes as depicted. The energy in the crosswind is transformed into a plurality of small vortexes as opposed to one larger vortex. Thus, the energy of the gust is dissipated by the small vortexes that are formed, most importantly in the direction of the spin axis of these small vortexes. They are 90 degrees from the direction that the original large vortex would normally form. As such, the vortex generators prevent the creation of a larger vortex on the leeward side of the trailer 102. The result is that the vessel 102 does not get sucked into the leeward side.

FIG. 10 shows vortex generators on both sides of the vessel 102. If the crosswinds were to change direction, then the vortex generators on the other side (the top side as depicted) would create the vortexes. This is why, in some embodiments, vortex generators 100 are placed on both sides of a vessel.

There are numerous benefits from the vortex generator. As noted, one is reduction of the impact of crosswinds which results in the trailer 102 not getting sucked into an adjacent lane due to swaying. Thus, safety is increased. As previously noted, if a driver was not paying sufficient attention, the driver could lose control. When the impact of the crosswind is reduced, the effect of the vessel 101, such as a trailer 102, being pulled due to the crosswind is significantly reduced. Thus, increased safety is an advantage.

Second, aside from increasing safety, the vortex generator 100 results in a gentler ride for both the driver and other passengers. Previously, the crosswind effect resulted in the entire vehicle and/or trailer shaking as it was being pulled toward the leeward side. Because this effect is reduced, the drive is calmer for both the driver and the passenger.

As noted, in some embodiments the vortex generator 100 is added to a vessel 102. In some embodiments the vortex generator 100 has an adhesive that allows it to adhere to a surface. In other embodiments the vortex generator 100 utilizes a screw, bolt, or the like to mechanically couple the vortex generator 100 to the vessel 102.

The vortex generator 100 is placed in the location described herein to reduce and decrease the impact of crosswinds. In embodiments wherein the vortex generators 100 are added to a vessel 101 or trailer 102, the vortex generator 100 can be coupled to the vessel via the methods described herein. In one embodiment, previously discussed, a plurality of vortex generators 100 are placed on the upper edge of each side of the vessel 102.

Additionally, as noted, in other embodiments rather than being added subsequently, the vortex generator 100 is built and manufactured simultaneously with the vessel 101 or trailer 102.

While the invention has been particularly shown and described with reference to a preferred embodiment, it will be understood by those skilled in the art that various changes in form and detail may be made therein without departing from the spirit and scope of the invention.

What is claimed is:

1. A vortex generator comprising:
a base;
a planar fine extending upward from said base.

2. The vortex generator of claim 1 wherein said fir arcs at each side to a high point located approximately in the horizontal center of the vortex generator.

3. The vortex generator of claim 1 wherein said vortex generator is injected molded polypropylene.

4. The vortex generator of claim 1 wherein said base comprises an acrylic foam adhesive tape.

5. The vortex generator of claim 1 wherein said base extends outwardly perpendicular to said fin.

6. A method of reducing sway on a trailer, said method comprising:
a) obtaining at least two vortex generators, wherein each of said vortex generator comprises a base and a planar fin extending upward from said base;
b) placing vortex generators on two vertical sides of a trailer.

7. The method of claim 6 wherein said at least vertical sides are on the front end of a trailer.

8. The method of claim 7 further comprising placing vortex generators on vertical sides at the rear of the trailer.

9. The method of claim 6 wherein said placing involves placing a pair of vortex generators on a vertical side 45 degrees to each other.

10. The method of claim 6 wherein said vertical sides comprise the front of a trailer, and wherein each side has four pairs of vortex generators.

11. The method of claim 6 further comprising the step of c) reducing the sway force when alongside a passing adjacent vehicle.

12. The method of claim 11 wherein said sway force is reduced by greater than 70%.

13. The method of claim 6 wherein said vortex generators are added to an existing trailer.

14. The method of claim 6 wherein placing occurs simultaneously with the manufacture of the trailer.

15. A method of reducing the impact of cross winds, said method comprising:
a) obtaining at least two vortex generators, wherein each of said vortex generator comprises a base and a planar fin extending upward from said base;
b) placing vortex generators atop each top side edges of a trailer, wherein said vortex generators are placed so that the fin is parallel with the length of the trailer.

16. The method of claim 15 wherein two or more vortex generators are placed along the top edge of the trailer, and wherein the two or more vortex generators are placed approximately 20 inches apart.

17. The method of claim 15 wherein when a crosswind encounters the vortex generators, the generators create a plurality of quickly dissipating vortexes.

18. The method of claim 15 wherein when a crosswind encounters the vortex generators, the vortex generators prevent the creation of a larger vortex on the leeward side of the trailer.

19. The method of claim 15 wherein said vortex generators are added to an existing trailer.

20. The method of claim 15 wherein placing occurs simultaneously with the manufacture of the trailer.
